(19) United States
(12) Patent Application Publication
(10) Pub. No.: US 2025/0222960 A1
(43) Pub. Date: Jul. 10, 2025

(54) MOTION FORECASTING IN AUTONOMOUS VEHICLES USING A MACHINE LEARNING MODEL TRAINED WITH CYCLE CONSISTENCY LOSS

(71) Applicant: Motional AD LLC, Boston, MA (US)

(72) Inventors: Titas Chakraborty, Boston, MA (US); Akshay Bhagat, Boston, MA (US); Henggang Cui, Boston, MA (US)

(21) Appl. No.: 19/093,079

(22) Filed: Mar. 27, 2025

Related U.S. Application Data
(63) Continuation of application No. PCT/US2023/075433, filed on Sep. 28, 2023.
(60) Provisional application No. 63/509,731, filed on Jun. 22, 2023.
(60) Provisional application No. 63/378,002, filed on Sep. 30, 2022.

(51) Int. Cl. B60W 60/00; G06N 20/00

(52) U.S. Cl. CPC B60W 60/0027; G06N 20/00

(57) ABSTRACT

Systems and methods are disclosed for motion forecasting in autonomous vehicles using a machine learning model trained with cycle consistency loss. Some machine learning models are trained to predict future object motion based on past observed motion, using ground truth knowledge of future object motion. In practice, such models are often inaccurate and thus unsuitable for safety-critical operations. Disclosed herein is an improved training mechanism for an object prediction model, which training mechanism utilizes cycle consistency loss. This loss can be calculated using an inverted motion prediction-that is, given observed motion and a predicted future motion, how likely the predicted future motion, if passed through the model as if it were historical data, would result in a prediction of the observed motion. Training based on inverted or backward motion prediction can improve an ability of a machine learning model to accurately predict future motion based on observed motion.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 4B is a diagram of an implementation of a neural network;

FIGS. 4C and 4D are a diagram illustrating example operation of a CNN;

FIGS. 5A and 5B are illustrative visualizations of training data for training a machine learning model using cycle consistency loss, including both forward and reverse temporal data;

FIG. 6 is a block diagram illustrating an example environment in which a system determines trains a machine learning model, using cycle consistency loss, to conduct object motion prediction;

FIG. 7 is a visualization of an example training process for training a machine learning model, using cycle consistency loss, to conduct object motion prediction;

FIG. 8 is a flowchart of an example process for training a machine learning model, using cycle consistency loss, to conduct object motion prediction.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

Generally described, aspects of the present disclosure relate to improving object motion forecasting, with applications in fields such as autonomous vehicles, by implement a machine learning model trained using cycle consistency loss. As described herein, object motion forecasting generally describes mechanisms for predicting future motion (e.g., a trajectory) of an object based on past observed motion of the object or other objects. For example, object motion forecasting may be applied in an autonomous vehicle to enable the vehicle to predict how other objects in or near a roadway will move, thereby enabling the autonomous vehicle to respond appropriately (e.g., to avoid collisions or other safety risks, to legally navigate a roadway, etc.). One mechanism for object motion forecasting is to implement a machine learning model, which may be trained on a historical data set reflecting observed motion of an object until a given point of time and actual motion of the object after that point in time. The machine learning model may be trained, using the historical data set, to predict the actual motion from the past observed motion, such that the model can be deployed to an autonomous vehicle to predict (not yet known) object motion based on observed motion. In practice, this simplified approach can be inaccurate, which may lead to safety and efficacy issues in an autonomous vehicle. The present disclosure relates to an improved machine learning model for object motion forecasting, where training is modified to include cycle consistency loss. As described herein, this loss can be calculated at least in part based on an inverted or backward motion prediction-that is, given observed motion and a predicted future motion, how likely the predicted future motion, if passed through the model as if it were historical data, would result in a prediction of the observed motion. This model can capture an intuitive understanding that many or most object movements are reversible, such that if a predicted forward motion could not be completed in reverse, it is unlikely to be an accurate prediction. Thus, training based on inverted or backward motion prediction can improve an ability of a machine learning model to accurately predict future motion based on observed motion.

As will be appreciated by one of skill in the art in light of the present disclosure, the embodiments disclosed herein improve the ability of computing systems to predict object motion based on historical object motion. In particular, embodiments of the present disclosure provide for increased accuracy in predicting object motion by training a machine learning model using of a cycle consistency loss factor, based at least partly on inverted or backward motion prediction. This increased accuracy, in turn, enables safer more effective operation of autonomous systems that rely on object motion prediction, such as autonomous vehicle. Moreover, the presently disclosed embodiments address technical problems inherent within computing systems; specifically, the difficulty of programmatically predicting object motion, and the difficulties of safely implementing various automated tasks without accurate object motion prediction. These technical problems are addressed by the various technical solutions described herein, including a machine learning model architecture including a cycle consistency loss factor during training. Thus, the present disclosure represents an improvement on machine learning computing systems and computing systems in general.

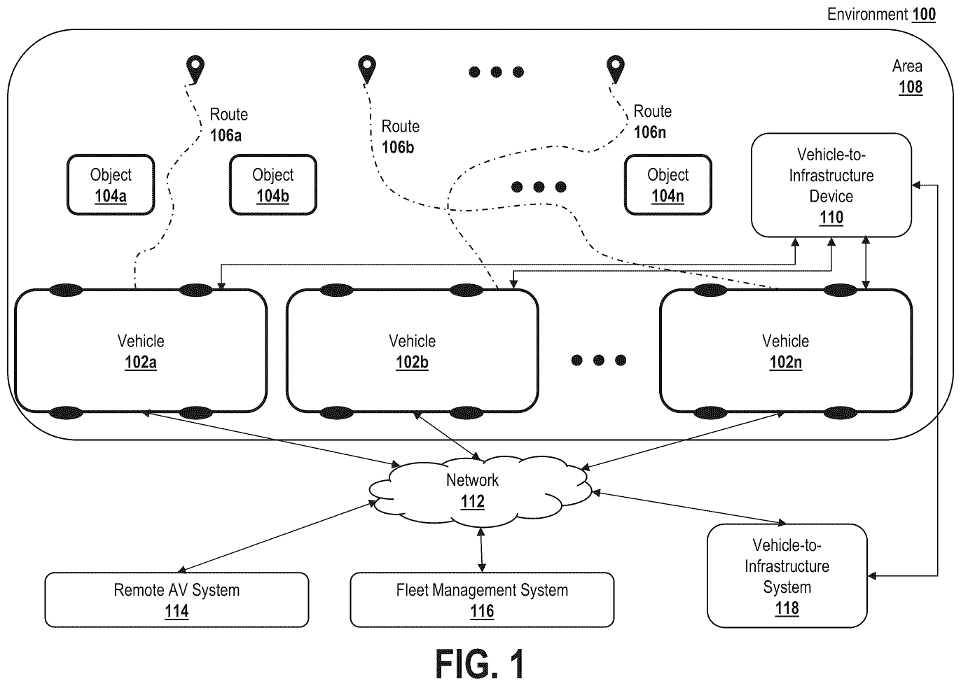

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V21) device 110, network 112, remote autonomous vehicle (AV) system 114, fleet management system 116, and V21 system 118. Vehicles 102a-102n, vehicle-to-infrastructure (V21) device 110, network 112, autonomous vehicle (AV) system 114, fleet management system 116, and V21 system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V21) device 110, network 112, autonomous vehicle (AV) system 114, fleet management system 116, and V21 system 118 via wired connections, wireless connections, or a combination of wired or wireless connections.

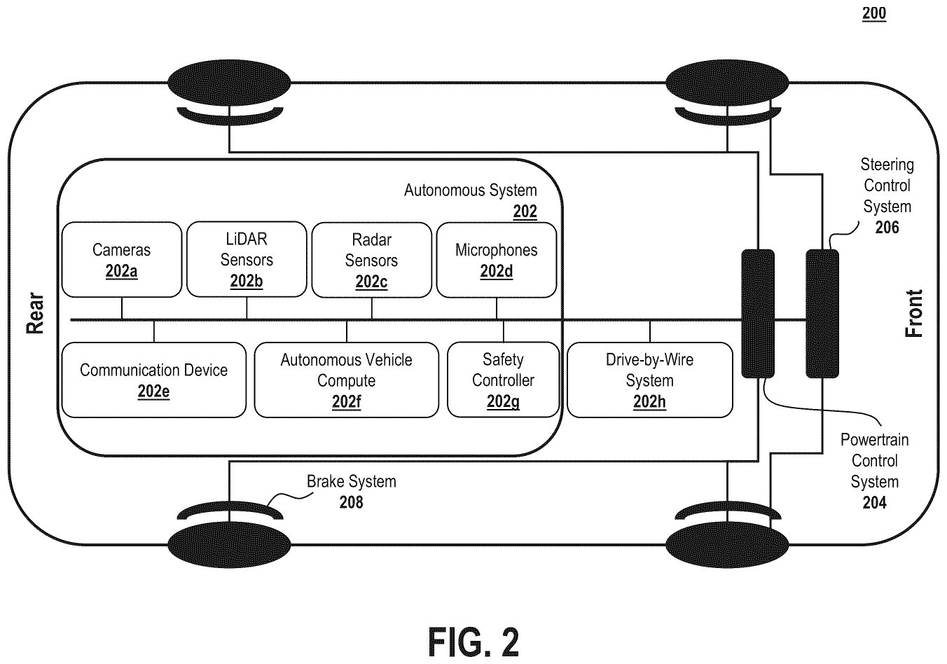

Vehicles 102a-102n (referred to individually as vehicle 102 and collectively as vehicles 102) include at least one device configured to transport goods and/or people. In some embodiments, vehicles 102 are configured to be in communication with V21 device 110, remote AV system 114, fleet management system 116, and/or V21 system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V21) device 110 (sometimes referred to as a Vehicle-to-Infrastructure or Vehicle-to-Everything (V2X) device) includes at least one device configured to be in communication with vehicles 102 and/or V21 infrastructure system 118. In some embodiments, V21 device 110 is configured to be in communication with vehicles 102, remote AV system 114, fleet management system 116, and/or V21 system 118 via network 112. In some embodiments, V21 device 110 includes a radio frequency identification (RFID) device, signage, cameras (e.g., two-dimensional (2D) and/or three-dimensional (3D) cameras), lane markers, streetlights, parking meters, etc. In some embodiments, V21 device 110 is configured to communicate directly with vehicles 102. Additionally, or alternatively, in some embodiments V21 device 110 is configured to communicate with vehicles 102, remote AV system 114, and/or fleet management system 116 via V21 system 118. In some embodiments, V21 device 110 is configured to communicate with V21 system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V21 device 110, network 112, fleet management system 116, and/or V21 system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V21 device 110, remote AV system 114, and/or V21 infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V21 system 118 includes at least one device configured to be in communication with vehicles 102, V21 device 110, remote AV system 114, and/or fleet management system 116 via network 112. In some examples, V21 system 118 is configured to be in communication with V21 device 110 via a connection different from network 112. In some embodiments, V21 system 118 includes a server, a group of servers, and/or other like devices. In some embodiments, V21 system 118 is associated with a municipality or a private institution (e.g., a private institution that maintains V21 device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

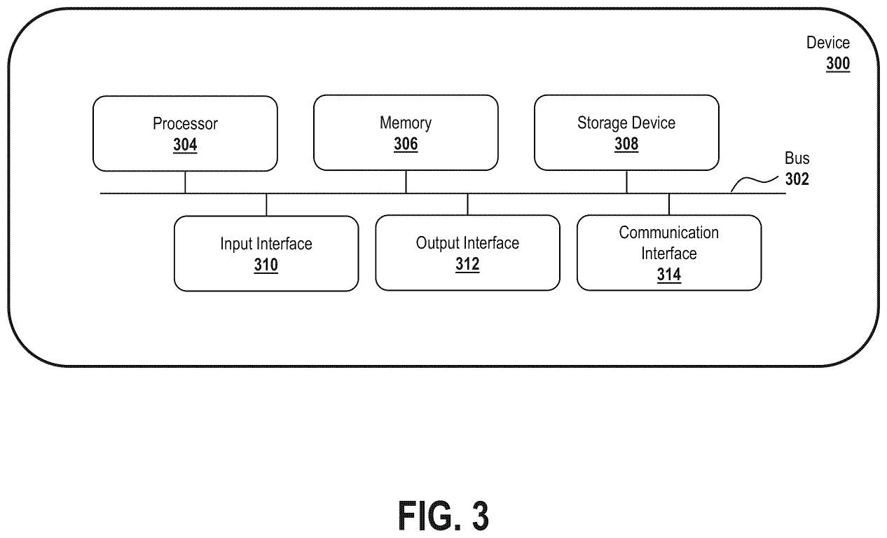

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V21 device (e.g., a V21 device that is the same as or similar to V21 device 110 of FIG. 1), and/or a V21 system (e.g., a V21 system that is the same as or similar to V21 system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102, and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, the processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

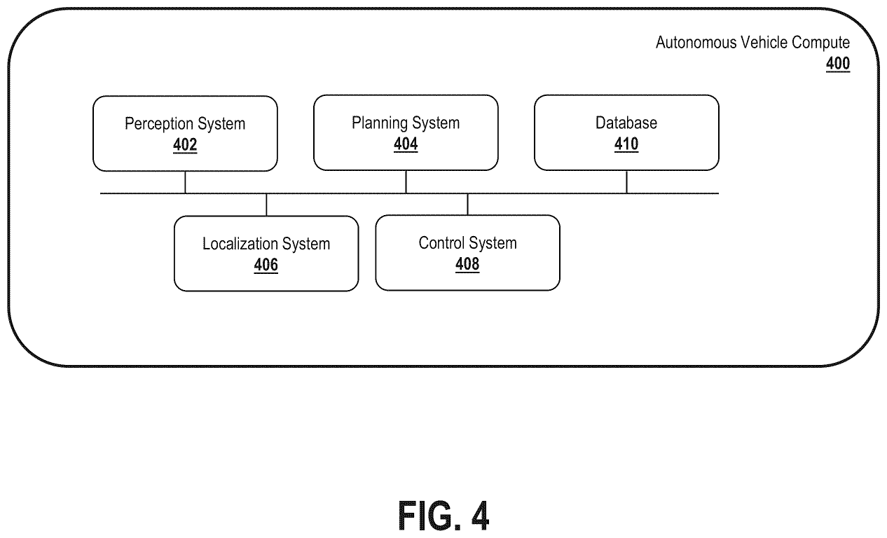

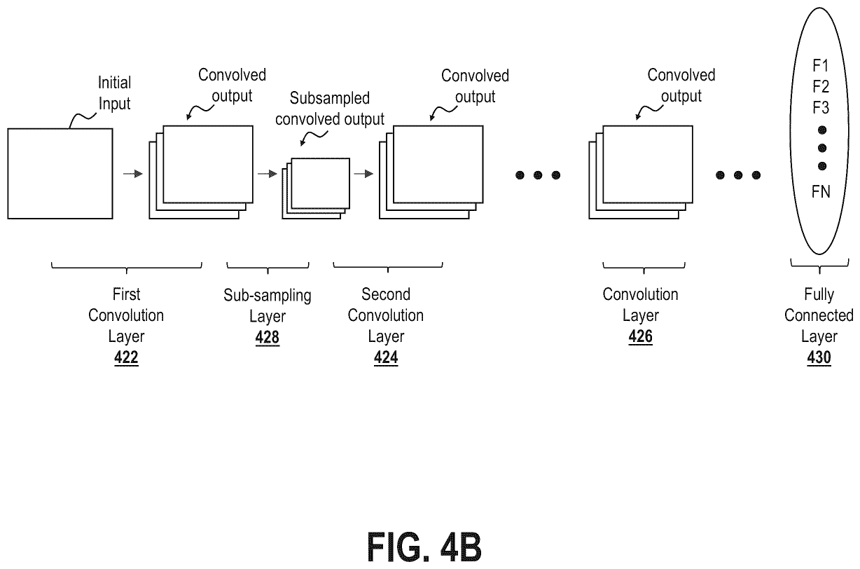

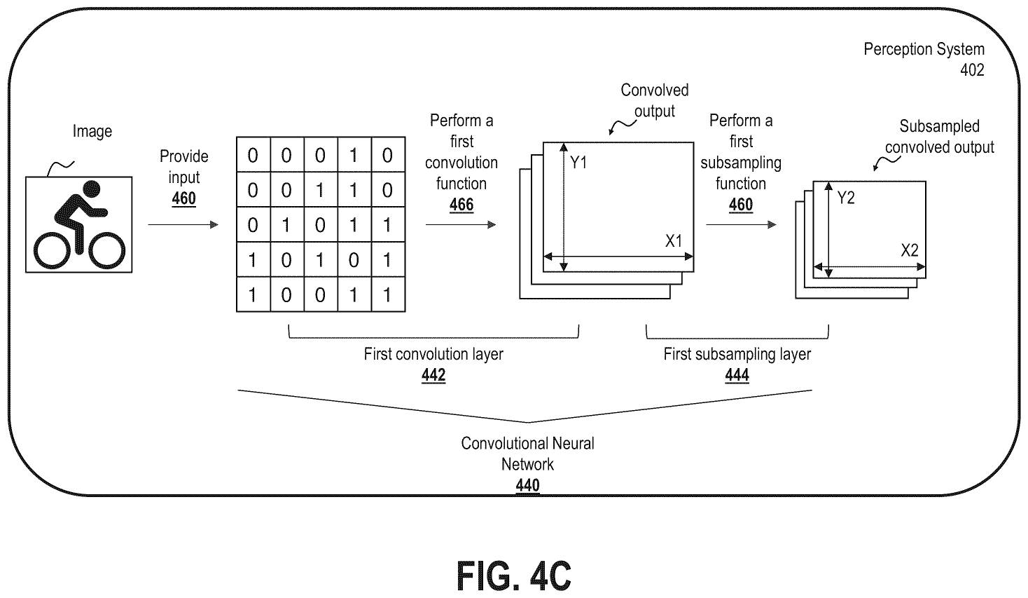

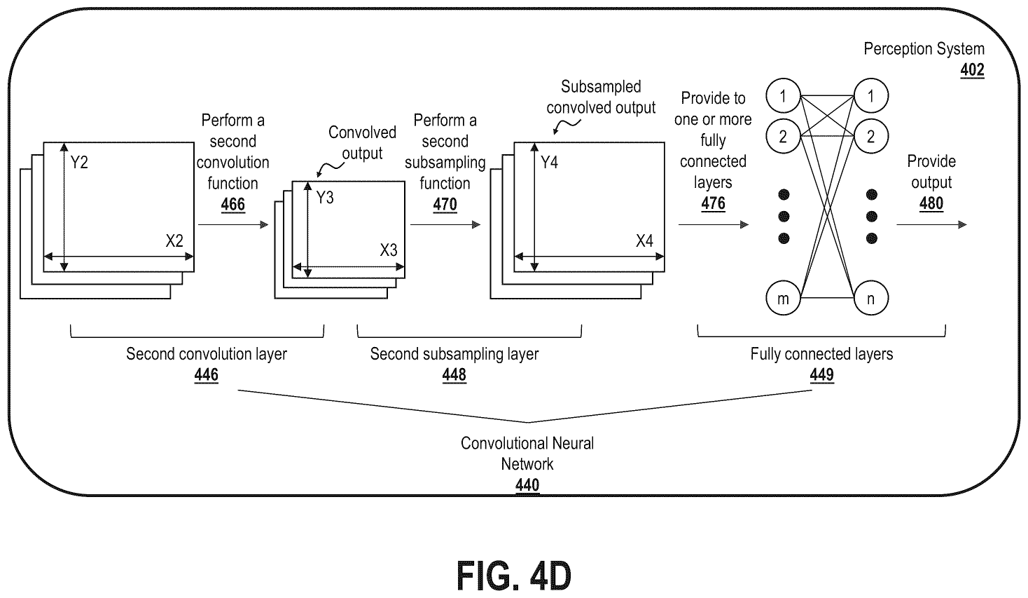

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICS), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V21 system that is the same as or similar to V21 system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V21 system (e.g., a V21 system that is the same as or similar to V21 system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V21 system that is the same as or similar to V21 system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 4 02 normalizing sensor data (e.g., image data, LiDAR data, radar data, and/or the like).

In some embodiments, CNN 420 generates an output based on perception system 4 02 performing convolution operations associated with each convolution layer. In some examples, CNN 420 generates an output based on perception system 4 02 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 43 0 includes data associated with a plurality of feature values referred to as F1, F2 . . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

### Motion Forecasting Using A Machine Learning Model Trained With Cycle Consistency Loss

As discussed above, it may be difficult to train a machine learning model, such as the CNNs described above, to accurately predict future object motion from past observed motion.

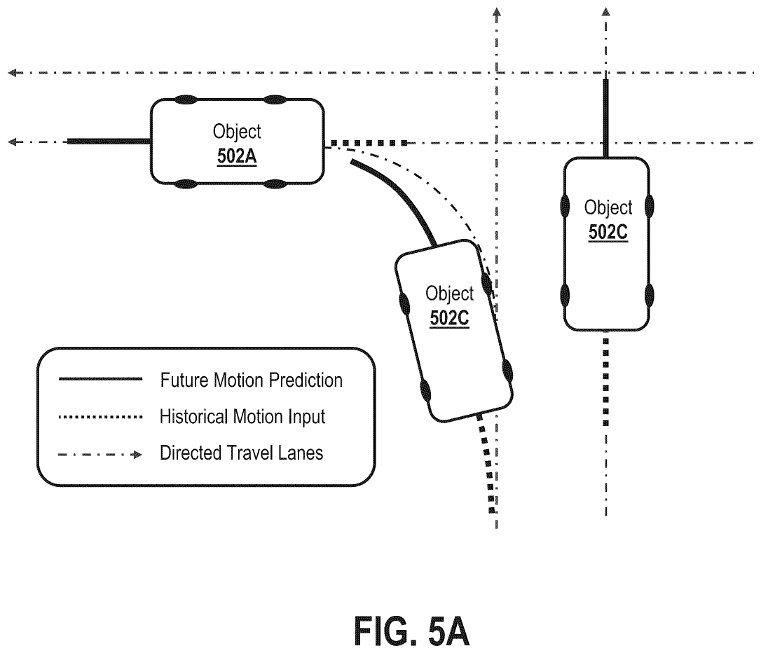

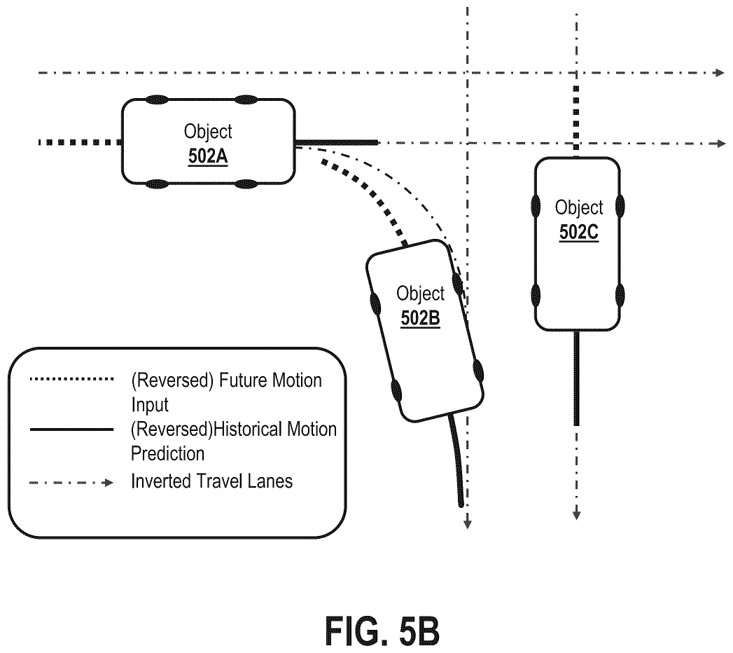

With reference to FIGS. 5A-8, embodiments will be described for improved motion forecasting by use of a machine learning model trained using cycle consistency loss. Specifically, embodiments will be described in which a machine learning model is trained using both forward temporal prediction, predicting future motion from past observed motion, and backwards (or inverted) temporal prediction, predicting observed motion from (predicted or known) future motion. By incorporating backwards temporal prediction during training, the accuracy of the resulting model can be improved relative to a model that is trained solely on forward temporal prediction. Such a model can then be deployed to enable more accurate motion prediction. For example, such a model may be loaded into an autonomous vehicle (such as the vehicle 102 of FIG. 1) to enable the vehicle to predict future object motion from past observed motion of the object (e.g., as observed using sensors of the vehicle). In one embodiment, backwards temporal prediction is implemented during training of the machine learning model, and not during inference. Thus, backwards temporal prediction can be used to improve accuracy of a model during inference without otherwise altering how the model is used when deployed.

The concept of backwards (or inverted) temporal prediction is further illustrated in the visualizations of FIGS. 5A and 5B, which visualize both forward and reverse temporal data that may be used as training data when training a machine learning model for object motion prediction. Specifically, FIG. 5A depicts forward temporal data that can be used during a forward pass corresponding to forward temporal prediction. FIG. 5B depicts backward (or inverted) temporal data that can be used during a backwards pass corresponding to backwards temporal prediction.

In the visualization of FIG. 5A, a number of objects 502A-C travel on a set of directed travel lanes. For example, the visualization of FIG. 5A may be a top-down (or birds-eye) view of a road intersection, with individual traffic lanes indicated as the directed travel lanes. Each object 502 may represent a controllable first-party entity, such as the autonomous vehicle 102 of FIG. 1, a target object for which motion predicted is desired, or another object also traveling within the directed travel lanes, whose movement may impact movement of the other objects. The visualization may be created, for example, based on data collected during operation of a first party vehicle, such as from sensors on the vehicle. One skilled in the art will appreciate that FIG. 5A is a simplified diagram, and that actual training data may be significantly more complex. For example, actual training data may include more directed travel lanes, more objects, more complex movement patterns, or the like.

As can be seen from FIG. 5A, forward motion prediction can generally involve predicting the future motion of an object from past observed motion. In FIG. 5A, past observed motion is indicated with solid lines, while future prediction motion is indicated with dotted lines. Accordingly, a machine learning model may be trained such that the future motion of a given object 502 is predicted when historical motion is input into the model. To facilitate training, a training data set may include ground truth values for future motion prediction-that is, observed motion of an object 502 subsequent to a given point in time, which is used to train the model.

An object prediction model may utilize only forward temporal prediction, based on data similar to that shown in FIG. 5A. However, to improve the accuracy of such a model, an improved model is disclosed that utilizes both forward temporal prediction and backward temporal prediction, which backward temporal prediction is visualized in FIG. 5B. Specifically, FIG. 5B depicts an inversion of the visualization of FIG. 5A, such that the directed travel lanes are inverted in direction, and such that future motion represents an input to a machine learning model, rather than an output. Accordingly, the directed travel lanes are reversed in FIG. 5B relative to FIG. 5A, thus corresponding to inverted travel lanes. While objects 502A-C are in the same locations in both FIGS. 5A and 5B, their direction of travel is reversed (e.g., such that object 502A is traveling rightward in FIG. 5A and leftward in FIG. 5B). Notably, this reversal does not reflect a different observed scenario, but rather the same scenario as FIG. 5A when reversed in time. In such a temporal reversal, each object moves from a future location to a past location.

Accordingly, when used as part of a training data set, the future motion of each object 502 (which may be predicted future motion, as generated during a forward pass of machine learning model, observed future motion reflected in ground truth data, or a combination thereof) represents input to a backwards pass through the model, while the historical motion of the object 502 is a prediction of the backwards pass. As noted above, this backward pass can act as a check against the predictions of a forward pass, ensuring that predicted future motion of the forward pass is reasonable. More specifically, because many or most movements in a given context (e.g., vehicles in a regulated roadway) are reversible, a backward pass may be used to represent an intuition that irreversible movements (e.g., such that an object could not travel back along a reversed path) are less likely to be accurate. Accordingly, training a machine learning model using inverted temporal data (e.g., as a backwards pass) can increase the accuracy of the model relative to using only non-inverted (forward) temporal data.

Notably, the techniques described herein are not necessarily limited to a particular machine learning model. Rather, these techniques may be applied to a wide variety of machine learning models. On example of such a model is the “Graph-Oriented Heatmap Output for future Motion Estimation” or “GOHOME” model, as disclosed in “GOHOME: Graph-Oriented Heatmap Output for future Motion” by Thomas Gilles et al., as published in the 2022 International Conference on Robotics and Automation (ICRA) (pages 9107-9114) (doi: 10.1109/ICRA46639.2022.9812253), which is incorporated by reference herein. Another example of such a model are “Autobots” models as disclosed in “Latent Variable Sequential Set Transformers For Joint Multi-Agent Motion Prediction” to Roger Girgis et al., as published in International Conference on Learning Representations, 2022 (doi: 10.48550/arXiv.2104.00563), which is incorporated by reference herein. In accordance with the present disclosure, such models may be modified to incorporate during training a backwards pass using inverted temporal data, thereby improving the accuracy of a trained model.

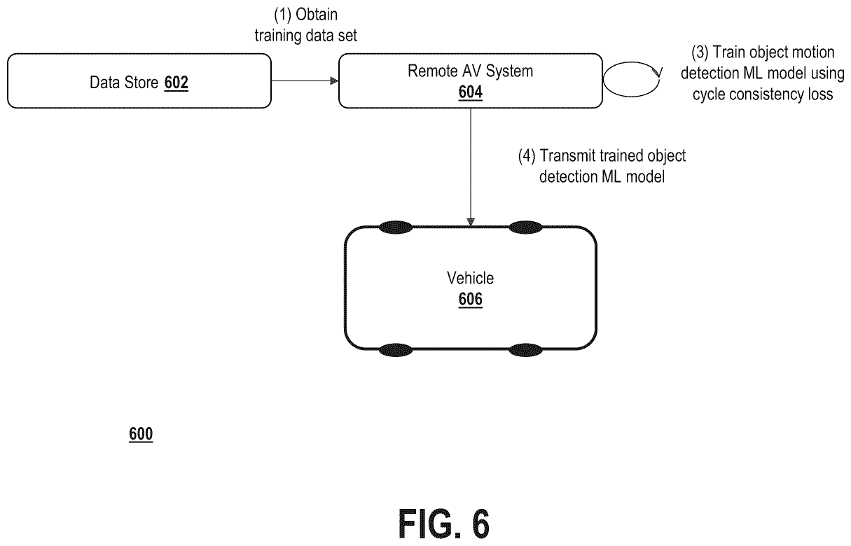

With reference to FIG. 6, illustrative interactions in an environment 600 will be described for implementing an improved machine learning model to conduct object motion forecasting by training the model using a backwards pass corresponding to inverted temporal data. The environment 600 illustratively includes a remote AV system 604, which may correspond for example to the remote AV system 114 of FIG. 1, and a vehicle 606, which may correspond for example to the vehicle 200 of FIG. 2.

The interactions of FIG. 6 being at (1), where the remote AV system 604 obtains a training data set from a data store 602, which may correspond to any persistent or substantially persistent data store. The training data set illustratively includes data corresponding to a number of observed object movements, such as in various locations, including both historical object movements prior to a given point in time (e.g., corresponding to an input to a trained model during inference) and observed object movements subsequent to the given point in time (e.g., corresponding to ground truth used to train the model to conduct such inference). Illustratively, the data may be generated based in whole or in part on operation of sensors within one or more autonomous vehicles. For example, the data may result from processing sensor data to generate a number of training instances, such as the instance visualized in FIG. 5A above. In some embodiments, the training data includes inverted temporal instances, each corresponding to an inversion of a forward temporal instance. In other embodiments, the data obtains only forward temporal instances, and the remote AV system 604 is configured to invert one or more such instances to generate inverted temporal instances (e.g., by in each instance inverting traffic lanes and swapping input and outputs, such that observed ground truth movements represent inputs and historical observed movements represent outputs, and vice versa).

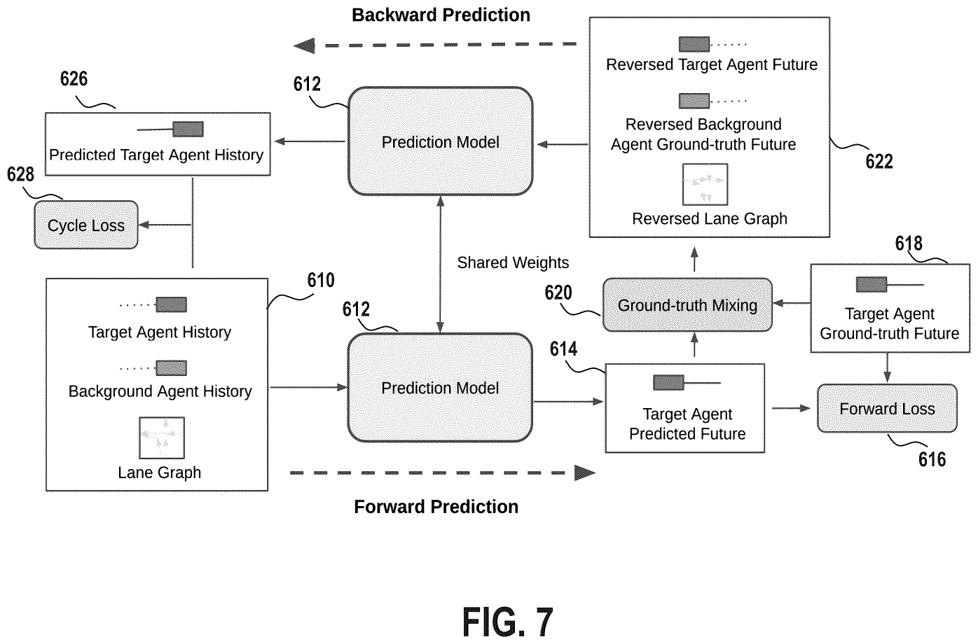

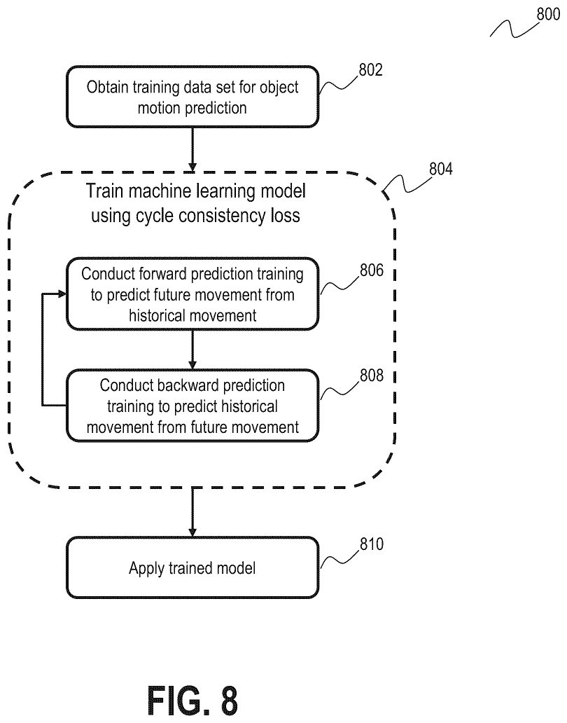

Thereafter, at (3), the remote AV system 604 trains a machine learning model to conduct object detection on the basis of the training data. Specifically, model may be trained using a combination of forward and backward passes, corresponding to processing forward or inverted temporal data, respectively. In accordance with machine learning algorithms, the error in prediction for each pass may be captured as a loss value that is used (e.g., via backpropagation) to modify weights of the model for a subsequent training step. Because the error in prediction for a backwards pass indicates a lack of consistency between the forwards and backwards pass, and because the forwards and backwards pass form a training cycle, the loss value for the backwards pass can be referred to as a cycle consistency loss. In accordance with the present disclosure, the modification of weights for the model using a cycle consistency loss can be seen to improve the accuracy of a resultant trained model, relative to a model trained using only forward loss. Further discussion regarding training of a machine learning model using cycle consistency loss is provided below with respect to FIGS. 7 and 8.

At (4), the remote AV system 604 can then transmit the trained object motion forecasting machine learning model to a vehicle 606. Because the model or models has been trained using cycle consistency loss, the models can be expected to have improved accuracy relative models trained without cycle consistency loss. Thus, the vehicle 606 may utilize the model to subsequently forecast object motion during operation of the vehicle 606, providing for safer and more effective operation.

The interactions of FIG. 6 may illustratively be repeated. For example, during operation of the vehicle 606, additional sensor data may be collected and used to generate training data that is stored in the data store 602, which data may then be used during subsequent iterations of the interactions of FIG. 6. Thus, the interactions of FIG. 6 may be used to iteratively improve performance of machine learning models interpreting sensor data, which may in turn improve various processes reliant on such models, such as operation of autonomous vehicle.

An illustrative training sequence for training a machine learning model using a cycle consistency loss is shown in FIG. 7. The sequence may be implemented, for example, by the remote AV system 604 of FIG. 6 during training of an object motion detection machine learning model.

Illustratively, the sequence may begin in a forward prediction pass, shown in the bottom of FIG. 7. During the forward prediction pass, a forward temporal training set instance 610, including for example historical and ground truth motion data for a target entity (also referred to as a target agent) moving with respect to a lane graph (e.g., traffic lanes on a roadway). The forward temporal training set instance 610 may further include historical motion data for other entities, referred to in FIG. 7 as “background agents.” For example, background agents may include other vehicles whose motion affects the motion of the target entity. While shown in FIG. 7 for illustrative purposes, forward temporal training set instance 610 may omit background agent data in some cases. Moreover, while a single target agent and single background agent are shown in FIG. 7, an instance 610 may include multiple target agents or multiple background agents.

As shown in FIG. 7, the forward prediction pass can include passing the forward temporal training set instance 610 through a prediction model 612, which as noted above may correspond to any variety of machine learning models. For example, the prediction model 612 may be a CNN, as described above, configured to generate a predicted motion of the target agent in the instance 610. As a result of passing the instance 610 through the model 612, the model 612 produces a predicted future motion 614 for the target agent, representing for example, a predicted trajectory of the agent during a period of time subsequent to that reflected in instance 610 as historical motion of the agent. This predicted future motion 614 can then be compared to ground truth data 618-that is, an observed actual motion of the agent during the period of time subsequent to that reflected in instance 610 as historical motion of the agent-to calculate a forward loss 616. In accordance with training algorithms for machine learning models, the forward loss 616 can the be used to modify weights of the model 612 such that subsequent predictions have improved accuracy.

In addition to the forward pass, the sequence of FIG. 7 includes a backward prediction pass, whereby an inverted (or reversed) temporal training set instance 622 is pass through the prediction model. The inverted temporal training set instance 622 is similar to the forward temporal training set instance 610, but inverted. Specifically, the inverted temporal training set instance 622 includes a lane graph that is reversed relative to the forward temporal training set instance 610. Moreover, input to the model 612 during the backwards prediction pass is not the historical motion, as in the instance 610, but rather a reversed future path. In one embodiment, the future path is the predicted future path 614 (e.g., the output of the model 612 from a prior forward prediction pass). In another embodiment, the future path is the ground truth future path 618.

In yet another embodiment, as shown in FIG. 7, the future path represented (in reverse) in inverted temporal training set instances 622 is a mixture of predicted future paths 614 and ground truth future paths 618. For example, a ground truth mixing 620 stage may select one of the predicted future path 614 from a past forward prediction or the corresponding ground truth future path 618 to reverse in the inverted temporal training set instance 622. Illustratively, the ground truth mixing stage 620 may randomly select between these two options according to a pre-defined weighting, which may be tuned during training of the model 612. In one embodiment, the pre-defined weighting is equal, such that there is a equal chance of using either the predicted future path 614 from a past forward prediction or the corresponding ground truth future path 618 in each backward prediction.

As another example, a ground truth mixing 620 stage may combine both the predicted future path 614 from a past forward prediction and the corresponding ground truth future path 618 to resulted in a blended future, which is reversed in an inverted temporal training set instance 622. Illustratively, an object path may be represented as a sequence of waypoints in a coordinate system, such as x,y coordinates. Each waypoint may reflect a location of the object at a given point in time (e.g., each subsequent second relative to a defined zero point). In one embodiment, ground truth mixing 620 may include generating a blended path that includes, as each waypoint in a sequence, a corresponding waypoint selected (with a given probability) from a predicted future path 614 or a ground truth future path 618. For example, where the predicted future path is a set of waypoints {A1-An} and the ground truth future path 618 is a set of waypoints {B1-Bn}, the blended future path may be a set of waypoints {C1-Cn}, where each value Cm is selected as either Aₘ or Bₘ according to a predefined probability (e.g., equal weighting). In another embodiment, ground truth mixing 620 may include generating a blended path that includes blended waypoints, each generated from a combination of corresponding waypoints in the predicted future path 614 or a ground truth future path 618. For example, if a given waypoint has x and y values, a blended waypoint may inherit an x value from a corresponding waypoint of a predicted future path 614 and a y value from a corresponding waypoint of a ground truth future path 618. As another example, a blended waypoint may be a middle point between the corresponding waypoints of the predicted future path 614 and ground truth future path 618 (e.g., a center point between the two respective waypoints). In some instances, use of ground truth mixing can further improve the accuracy of the prediction model when trained using backward prediction passes.

As shown in FIG. 7, the inverted temporal training set instance 622 is then fed through the model 612 to result in a predicted target agent history 626-that is, the predicted (reversed) historical path of the object given the reversed future path. This predicted target agent history 626 can then be used to compute a cycle consistency loss 628 that, like the forward loss 616, is used to modify weights of the prediction model 612 such that the model 612 more accurately reflects the training data. For example, the predicted target agent history 626 may be reversed and compared to the corresponding target agent history in the forward temporal training set instance 610, with the cycle consistency loss value indicating how closely the predicted target agent history 626 matches the corresponding target agent history.

The sequence of FIG. 7 may then continue while additional training data exists, such that after the training data is processed, the prediction model 612 is trained to accurately forecast future object trajectories from observed object trajectories.

While FIG. 7 is described as beginning at a forward prediction pass, in some instances the sequence may begin at the backward prediction pass, such as by using only a ground truth future path 618 in an initial inverted temporal training set instance 622. The sequence may then proceed as described above.

With reference to FIG. 8, an illustrative routine 800 will be described for motion forecasting in autonomous vehicles using a machine learning model trained with cycle consistency loss. The routine 800 may be implemented, for example, by the remote AV system 604 of FIG. 6.

The routine 800 begins at block 802, where the remote AV system 604 obtains a training data set for object motion prediction. In accordance with the description above, the training data set may reflect a number of forward temporal training set instances, each instance reflecting movement of a given set of objects within an environment. For example, each instance may reflect a particular navigable area of an autonomous vehicle (e.g., a roadway, an intersection, etc.), locations of objects (e.g., vehicles, pedestrians, bicycles, etc.) in that area at a given point in time (e.g., a time t), historical movements of the objects prior to the point in time (e.g., at t-1 second, t-2 seconds, etc.), and ground truth movement for at least one object subsequent to the point in time (e.g., at t+1 second, t+2 seconds, etc.). The particular area and objects may vary across instances, or be repeated in multiple instances. For example, multiple instances may reflect movement of different objects in the same area, or may reflect movement of the same objects in different areas. In one embodiment, the instances are generated based on sensor data collected from one or more autonomous vehicles in each respective area. For example, sensor data collected from lidar, radar, or cameras of a vehicle may be processed to generate the instances.

Thereafter, at block 804, the remote AV system 604 trains a machine learning model using a cycle consistency loss. As discussed above, training a machine learning model may include passing each instance of the training data set through an initial model (e.g., with randomly initialized weights), comparing a prediction of the model at each pass with corresponding ground truth data for the instance, and adjusting the weights of the model to make predictions more reflective of the ground truth.

In accordance with embodiments of the present disclosure, each training iteration of block 804 may include both a forrad prediction pass and a backwards prediction pass. Specifically, at sub-block 806, the remote AV system 604 conducts a forward prediction training pass to predict future movement form historical data. Illustratively, the remote AV system 604 may pass an instance through the model to predict forward motion of a target object based on historical motion of that and/or other objects. Weights of the model may then be updated based on a forward loss that compares the predicted forward motion to ground truth forward motion for the instance. Thereafter, at sub-block 808, the remote AV system 604 conducts a backward prediction training pass to predict (reversed) historical data from (reversed) future movement. As noted above, the future movement may be the predicted future movement of sub-block 806, the ground truth movement of sub-block 806, or a blending thereof. The historical data may be that used to predict the future movement of sub-block 806. Both the future movement and the historical movement is illustratively reversed along with other relevant data, such as a lane graph (e.g., such that data at t-1 becomes data at t+1, etc.). The reversed future movement is then passed through the model in a backwards prediction pass, such that the model generates predicted historical movement. The predicted historical movement can then be compared to the historical movement of the corresponding forward prediction pass, which represents “ground truth” data for the backward prediction path. Specifically, a cycle consistency loss function may quantify how closely the predicted historical movement matches the historical movement of the training data set instance. Weights of the model may then be updated based on the cycle consistency loss, such that the model in subsequent passes more accurately predicts historical movement from future movement.

As noted above, incorporation of a backward prediction training pass, and particularly a backward prediction training pass that utilizes ground truth mixing to generate future movement used as input to such a backward prediction training pass, can improve the accuracy of the model relative to training such a model using only a forward prediction path.

Thereafter, at block 810, the trained model resulting from block 804 can be applied to forecast future object motion from observed object motion. For example, the model may be loaded into an autonomous vehicle such that a computing device of the vehicle can pass observed object motion (e.g., derived from sensor data of the vehicle) through the trained model to predict future object motion. Accordingly, application of a model as in the routine 800 can provide for safer and more efficient operation of devices that rely on accurate motion prediction, such as autonomous vehicles.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
obtaining a training data set for object motion prediction, the training data set including movement data associated with an object, the movement data indicating historical movement of the object prior to a point in time and ground truth movement of the object subsequent to the point in time;
training a machine learning model, wherein training the machine learning model comprises:
conducting a forward temporal prediction training pass to predict, from the historical movement for the object, a predicted future motion of the object subsequent to the point in time;
conducting a backward temporal prediction training pass to predict, from the predicted future motion, a predicted historical motion of the object prior to the point in time; and
modifying weights of the machine learning model based on a comparison between the predicted historical motion and the historical movement indicated in the movement data for the object; and
providing the trained machine learning model to an autonomous vehicle, wherein the autonomous vehicle is configured to utilize the trained machine learning model to forecast future object motion from observed object motion.

2. The method of claim 1, wherein the object is a target entity moving with respect to a lane graph.

3. The method of claim 1, wherein the training data set includes movement data for one or more additional objects indicating a position of the one or more additional objects relative to the object, historical movement of the one or more additional objects prior to the point in time, and ground truth movement of the one or more additional objects subsequent to the point in time.

4. The method of claim 1, wherein conducting a backward temporal prediction training pass to predict, from the predicted future motion, a predicted historical motion of the object prior to the point in time comprises inverting the predicted future motion.

5. The method of claim 1, wherein the comparison between the predicted historical motion and the historical movement indicated in the movement data for the object is a comparison between an inversion of the predicted historical motion and the historical movement for the object indicated in the movement data for the object.

6. The method of claim 1, wherein the backward temporal prediction training pass further predicts the predicted historical motion of the object based on the ground truth movement of the object.

7. The method of claim 1, wherein the training data set further includes movement data for a second object indicating historical movement of the second object prior to a second point in time and ground truth movement of the second object subsequent to the second point in time, and wherein training the machine learning model further comprises:
conducting a second forward temporal prediction training pass to predict, from the historical movement for the second object, a predicted future motion of the second object subsequent to the second point in time;
selecting at least one of the predicted future motion of the second object or the ground truth movement of the second object to use as an input for a subsequent backward temporal prediction training pass;
conducting the subsequent backward temporal prediction training pass to predict, from the input, a predicted historical motion of the second object prior to the second point in time; and
modifying the weights of the machine learning model based on a comparison between the predicted historical motion of the second object and the historical movement of the second object indicated in the movement data for the second object.

8. The method of claim 1, wherein data in the training data set is generated based in whole or in part on operation of sensors within one or more autonomous vehicles.

9. The method of claim 1, wherein the training data set includes data representing object movement in multiple physical locations.

10. The method of claim 1, wherein training the machine learning model further comprises modifying weights of the machine learning model based on a comparison between the predicted future motion and the ground truth movement.

11. The method of claim 1, wherein the comparison between the predicted historical motion and the historical movement indicated in the movement data for the object comprises calculating a result of a cycle consistency loss function.

12. The method of claim 11, wherein the cycle consistency loss function quantifies how closely the predicted historical motion of the object matches the historical movement for the object.

13. A system, comprising:
a processor configured to execute computer-executable instructions; and
a data store storing computer-executable instructions that, when executed by the processor, cause the system to:
obtain a training data set for object motion prediction, the training data set including movement data associated with an object, the movement data indicating historical movement of the object prior to a point in time and ground truth movement of the object subsequent to the point in time;
train a machine learning model, wherein training the machine learning model comprises:
conducting a forward temporal prediction training pass to predict, from the historical movement for the object, a predicted future motion of the object subsequent to the point in time;
conducting a backward temporal prediction training pass to predict, from the predicted future motion, a predicted historical motion of the object prior to the point in time; and
modifying weights of the machine learning model based on a comparison between the predicted historical motion and the historical movement indicated in the movement data for the object; and
provide the trained machine learning model to an autonomous vehicle, wherein the autonomous vehicle is configured to utilize the trained machine learning model to forecast future object motion from observed object motion.

14. The system of claim 13, wherein the backward temporal prediction training pass further predicts the predicted historical motion of the object based on the ground truth movement of the object.

15. The system of claim 13, wherein the training data set further includes movement data for a second object indicating historical movement of the second object prior to a second point in time and ground truth movement of the second object subsequent to the second point in time, and wherein training the machine learning model further comprises:
conducting a second forward temporal prediction training pass to predict, from the historical movement for the second object, a predicted future motion of the second object subsequent to the second point in time;
selecting at least one of the predicted future motion of the second object or the ground truth movement of the second object to use as an input for a subsequent backward temporal prediction training pass;
conducting the subsequent backward temporal prediction training pass to predict, from the input, a predicted historical motion of the second object prior to the second point in time; and
modifying the weights of the machine learning model based on a comparison between the predicted historical motion of the second object and the historical movement of the second object indicated in the movement data for the second object.

16. The system of claim 13, wherein training the machine learning model further comprises modifying weights of the machine learning model based on a comparison between the predicted future motion and the ground truth movement.

17. The system of claim 13, wherein the comparison between the predicted historical motion and the historical movement indicated in the movement data for the object comprises calculating a result of a cycle consistency loss function.

18. One or more non-transitory computer-readable media comprising computer-executable instructions that, when executed by a computing system comprising a processor, cause the computing system to:
obtain a training data set for object motion prediction, the training data set including movement data associated with an object, the movement data indicating historical movement of the object prior to a point in time and ground truth movement of the object subsequent to the point in time;
train a machine learning model, wherein training the machine learning model comprises:
conducting a forward temporal prediction training pass to predict, from the historical movement for the object, a predicted future motion of the object subsequent to the point in time;
conducting a backward temporal prediction training pass to predict, from the predicted future motion, a predicted historical motion of the object prior to the point in time; and
modifying weights of the machine learning model based on a comparison between the predicted historical motion and the historical movement indicated in the movement data for the object; and
provide the trained machine learning model to an autonomous vehicle, wherein the autonomous vehicle is configured to utilize the trained machine learning model to forecast future object motion from observed object motion.

19. The one or more non-transitory computer-readable media of claim 18, wherein the backward temporal prediction training pass further predicts the predicted historical motion of the object based on the ground truth movement of the object.

20. The one or more non-transitory computer-readable media of claim 18, wherein the comparison between the predicted historical motion and the historical movement indicated in the movement data for the object comprises calculating a result of a cycle consistency loss function.
